(19) United States
(12) Patent Application Publication
(10) Pub. No.: US 2023/0059419 A1
(43) Pub. Date: Feb. 23, 2023

(54) METHOD OF CONDITIONAL RECONFIGURATION AND USER EQUIPMENT USING THE SAME

(71) Applicant: Industrial Technology Research Institute, Hsinchu (TW)

(72) Inventor: Nai-Lun Huang, Hsinchu County (TW)

(73) Assignee: Industrial Technology Research Institute, Hsinchu (TW)

(21) Appl. No.: 17/893,181

(22) Filed: Aug. 23, 2022

Related U.S. Application Data
(60) Provisional application No. 63/235,810, filed on Aug. 23, 2021.

(51) Int. Cl. H04W 36/00; H04W 76/30

(52) U.S. Cl. CPC H04W 36/00837; H04W 36/0061; H04W 76/30

(57) ABSTRACT

Provided are a method of conditional reconfiguration and a user equipment (UE) using the same. The method is adapted to a user equipment and includes the following steps. A conditional reconfiguration including at least one candidate cell is received. A notification to network is transmitted in response to a release condition corresponding to one of the at least one candidate cell is fulfilled.

### CROSS-REFERENCE TO RELATED APPLICATION

This application claims the priority benefit of U.S. provisional application Ser. No. 63/235,810, filed on Aug. 23, 2021. The entirety of the above-mentioned patent application is hereby incorporated by reference herein and made a part of this specification.

### TECHNICAL FIELD

The disclosure relates to a method of conditional reconfiguration and a user equipment using the same.

### BACKGROUND

In a wireless communication system, handover, primary secondary cell (PSCell) change, or PSCell addition procedure is performed to support UE mobility or Dual Connectivity (DC) maintenance and setup. When handover failure or radio link failure (RLF) occurs, the UE needs to perform radio resource control (RRC) connection re-establishment, which takes a long time and impairs the user experience dramatically. In the 3rd generation partnership project (3GPP) specification Release-16/17, a Conditional Handover (CHO) mechanism, a Conditional PSCell Change (CPC) mechanism and a Conditional PSCell Addition (CPA) mechanism are introduced that allow UE to decide whether to perform handover, PSCell change, or PSCell addition when certain conditions are met, wherein the CHO mechanism is described in 3GPP TS 38.300 and the CPC mechanism and CPA mechanism are described in 3GPP TS 37.340. The CHO, CPC, or CPA configured by the network may include multiple candidate cells which may be served as possible target cells. That is, the candidate cells are prepared in advanced before the handover, PSCell change, or PSCell addition procedure is actually performed. However, due to fast fading of channel quality in high-frequency scenarios and high-speed movement of the UE, the candidate cells which has been configured to the UE may become outdated and no longer be suitable for the UE. Further, the resource reserved by the outdated candidate cells for handover, PSCell change, or PSCell addition may be useless and wasted. On the other hand, there may be other neighbor cells becoming competent to be the candidate cells. However, according to the current mechanism, the network knows nothing about whether the candidate cells have been incompetent or there is an other neighbor cell becoming competent to be one candidate cell.

### SUMMARY

The disclosure relates to a method of conditional reconfiguration and a user equipment using the same.

An embodiment of the disclosure relates to a method of conditional reconfiguration. The method is adapted to a user equipment and includes, but not limited to, the following steps.

A conditional reconfiguration comprising at least one candidate cell is received. A notification is transmitted to network in response to a release condition corresponding to one of the at least one candidate cell is fulfilled.

An embodiment of the disclosure relates to a user equipment including, but not limited to, a transceiver and a processor. The transceiver is configured to receive and transmit a signal.

The processor is coupled to the transceiver and is configured to execute the following steps. A conditional reconfiguration comprising at least one candidate cell is received. A notification is transmitted to network in response to a release condition corresponding to one of the at least one candidate cell is fulfilled.

In order to make the aforementioned features of the disclosure comprehensible, embodiments accompanied with drawings are described in detail below.

### BRIEF DESCRIPTION OF THE DRAWINGS

The accompanying drawings are included to provide further understanding of the disclosure, and are incorporated in and constitute a part of this specification. The drawings illustrate embodiments of the disclosure and, together with the description, serve to explain the principles of the disclosure.

FIG. 1 is a schematic diagram of a wireless communication system according to an exemplary embodiment of the disclosure.

FIG. 2 is a block diagram of a user equipment according to an exemplary embodiment of the disclosure.

FIG. 3 is a flow chart of a method of conditional reconfiguration according to an exemplary embodiment of the disclosure.

FIG. 4A is a schematic diagram illustrating fulfillment of an execution condition according to an exemplary embodiment of the disclosure.

FIG. 4B is a schematic diagram illustrating fulfillment of a release condition according to an exemplary embodiment of the disclosure.

FIG. 5 is a flow chart of a method of conditional reconfiguration according to an embodiment of the disclosure.

FIG. 6 is a flow chart of a method of conditional reconfiguration according to an embodiment of the disclosure.

FIG. 7 is a flow chart of a method of conditional reconfiguration according to an embodiment of the disclosure.

FIG. 8 is a flow chart of a method of conditional reconfiguration according to an embodiment of the disclosure.

FIG. 9 is a flow chart of a method of conditional reconfiguration according to an embodiment of the disclosure.

FIG. 10 is a schematic diagram illustrating releasing the candidate cells and adding new candidate cells according to an embodiment of the disclosure.

FIG. 11 is a flow chart of a method of conditional reconfiguration according to an embodiment of the disclosure.

FIG. 12 is a flow chart of a method of conditional reconfiguration according to an embodiment of the disclosure.

FIG. 13 is a flow chart of a method of conditional reconfiguration according to an embodiment of the disclosure.

FIG. 14 is a flow chart of a method of conditional reconfiguration according to an embodiment of the disclosure.

### DESCRIPTION OF THE EMBODIMENTS

In order to facilitate understanding of the aforementioned features and advantages of the disclosure, exemplary embodiments accompanied with drawings are described in detail below. It is to be understood that both the foregoing general description and the following detailed description are exemplary, and are intended to provide further explanation of the disclosure as claimed.

The term “user equipment” (UE) in the disclosure may be, for example, a mobile station (MS), an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held device, a music device, a wireless sensor, a cellphone, or the like. In some applications, a UE may be a fixed computer device operating in a mobile environment such as a bus, a train, an airplane, a boat, a car, or the like.

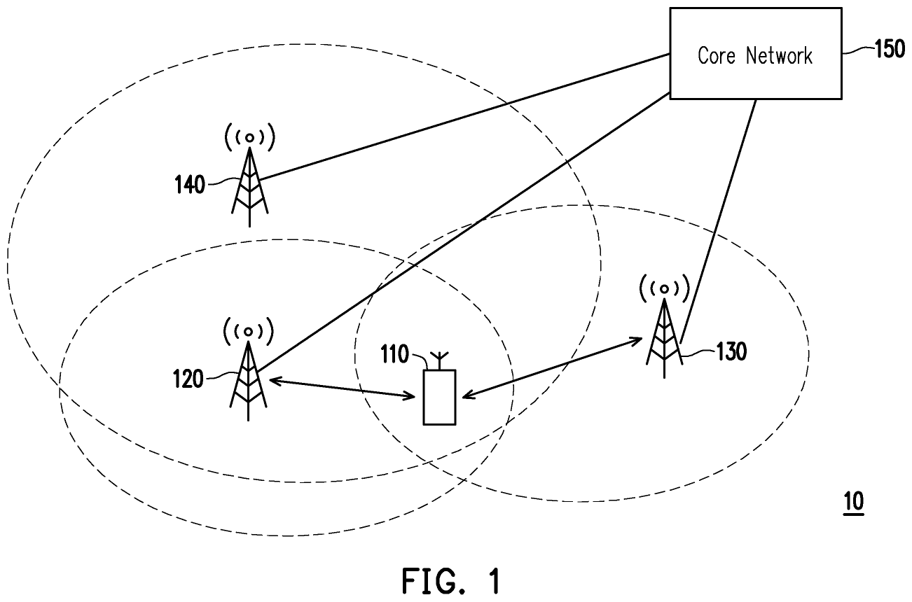

FIG. 1 is a schematic diagram of a wireless communication system according to an embodiment of the disclosure. Referring to FIG. 1, a wireless communication system 10 includes but not limited to a UE 110, a base station (BS) 120, a BS 130, a BS 140 and a core network 150. Although FIG. 1 illustrates three BS 120, 130 and 140 and one UE 110, the number of BS and the number of UE is not limited in the disclosure.

The BS 120, 130 and 140 (or referred to as radio access network (RAN) equipment) may be equipment that capable of communicating with the UE 110 through radio signals. Each of the BS 120, 130 and 140 may provide communication coverage for a specific geographic area and may communicate with UE 110 located in the coverage area. The coverage area of each BS 120, 130 and 140 may include one cell or multiple cells. Optionally, the BS 120, 130 and 140 may be implemented as a home evolved node B (HeNB), an evolved node B (eNB), a next generation node B (gNB), a base transceiver system (BTS), a relay, a repeater, or network equipment in the future evolution of the public land mobile network (PLMN), and the like. The BS 120, 130 and 140 may be interconnected with each other via X2 or Xn interface. The term “network” in the disclosure may include a RAN network including the BS 120, 130 and 140, the core network 150, or the combination thereof.

In FIG. 1, the cell of BS 120 partially overlaps with both of cells of BS 130 and 140. The overlap of the cells allows the UE 110 to implement a DC technology. For example, the UE 110 may be simultaneously connected to the BS 120 and the BS 130 through the DC technology. One of the BS 120 and the BS 130 may serve as a master node (MN), and the other of the BS 120 and the BS 130 may serve as a secondary node (SN). In the DC architecture, the UE may be connected to a master cell group (MCG) corresponding to the master node and a secondary cell group (SCG) corresponding to the secondary node. The MCG and the SCG may respectively include multiple service cells aggregating based on the carrier aggregation (CA) technology. The MCG may include a primary cell (PCell) and at least one secondary cell (SCell). The SCG may include a PSCell and at least one secondary cell (SCell). Besides, a special cell (SpCell) refers to the PCell of the MCG or the PSCell of the SCG.

In some embodiments, the core network 150 may include a fifth-generation core (5GC) and/or evolved packet core (EPC). Correspondingly, the BS 120, 130 and 140 may be connected to the core network 150 via S1 interface or NG interface. EPC may include equipment, such as a Serving Gateway (S-GW) and a Mobility Management Entity (MME). The S-GW is generally configured to transfer user-plane packets related to audio calls, video calls, Internet traffic, etc., and the MME is generally configured to manage authentication, registration, paging, and other related functions. Besides, the 5GC may include multiple network functions, such as a User Plane Function (UPF) and an Access and Mobility Management Function (AMF). The UPF is generally configured to transfer user-plane packets related to audio calls, video calls, Internet traffic, etc., and the AMF is generally configured to manage authentication, registration, paging, and other related functions. Note that according to the mobile communication standards of different generations, types and functions of equipment in the core network may vary, and the disclosure is not limited thereto.

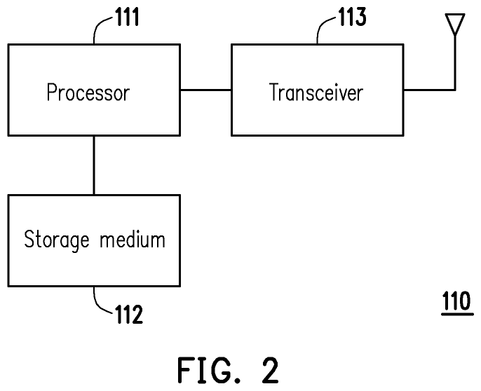

FIG. 2 is a block diagram of a user equipment according to an embodiment of the disclosure. Referring to FIG. 2, the UE 110 may at least include, but not limited to, a processor 111, a storage medium 112, and a transceiver 113.

The processor 111 is, for example, a central processing unit (CPU), other programmable general-purpose or specific-purpose microprocessor, a digital signal processor (DSP), a programmable controller, an application specific integrated circuit (ASIC), a graphics processing unit (GPU), other similar element, or a combination of the above elements. The processor 111 is configured to execute a method of conditional reconfiguration which will be described afterward.

The storage medium 112 is coupled to the processor 111 and is, for example, any type of fixed or mobile volatile memory or non-volatile memory, such as a random access memory (RAM), a read-only memory (ROM), a flash memory, a hard disk (HDD), a solid state drive (SSD), other similar element, or a combination of the above elements. The storage medium 112 stores multiple modules or programs to be accessed by the processor 111 so that the processor 111 may execute various communication functions of the UE 110.

The transceiver 113 is coupled to the processor 111. The transceiver 113 may receive a downlink (DL) signal and transmit an uplink (UL) signal. The transceiver 113 may execute operations such as low noise amplification (LNA), impedance matching, analog-to-digital conversion (ADC), digital-to-analog conversion (DAC), frequency mixing, up and down frequency conversion, filtration, amplification, and/or similar operations. The transceiver 113 may further include an antenna array, and the antenna array may include one or multiple antennas configured to transmit and receive an omnidirectional antenna beam or a directional antenna beam.

When the UE 110 moves among different cells, the original serving cell may become being not able to provide services for the UE 110 or the quality of service provided for the UE 110 may become poor. In order not to interrupt services, the serving cell needs to be changed and the UE 110 need to be switched to a more suitable cell capable of continuing services. The original serving cell may be referred to as a source cell, and the more suitable cell that provides continuous service for the UE 110 may be referred to as a target cell. A process of switching the UE 110 from the source cell to the target cell is handover. The source cell and the target cell may belong to the same base station, or the source cell and the target cell may belong to the different base stations. For example, the UE 110 may handover between the cells provided by the BS 120. Alternatively, the UE 110 may handover between one cell provided by the BS 120 to another one cell provided by the BS 130.

In the embodiments of the disclosure, a CHO is defined as a handover that is executed by the UE 110 when a CHO execution condition is fulfilled. The UE 110 may start evaluating the execution conditions upon receiving a CHO configuration, and may stop evaluating the execution conditions once a handover is executed. The CHO configuration may include one or multiple candidate cells and their corresponding execution conditions. That is, when the execution condition of one certain candidate cell is fulfilled, the corresponding candidate cell may be selected to be a target cell for handover. In some embodiments, the UE 110 may receive the CHO configuration by receiving a RRC reconfiguration message.

In the embodiments of the disclosure, a CPC is defined as a PSCell change that is executed by the UE 110 when a CPC execution condition is fulfilled. The UE 110 may start evaluating the execution conditions upon receiving a CPC configuration, and may stop evaluating the execution conditions once a PSCell change is executed. The CPC configuration may include one or multiple candidate cells and their corresponding execution conditions. In some embodiments, the UE 110 may receive the CPC configuration by receiving a RRC reconfiguration message.

In the embodiments of the disclosure, a CPA is defined as a PSCell addition that is executed by the UE 110 when a CPA execution condition is fulfilled. The UE 110 may start evaluating the execution conditions upon receiving a CPA configuration, and may stop evaluating the execution conditions once a PSCell addition is executed. The CPA configuration may include one or multiple candidate cells and their corresponding execution conditions. In some embodiments, the UE 110 may receive the CPA configuration by receiving a RRC reconfiguration message.

In the embodiments of the disclosure, the network may configure the UE 110 to perform measurements, which is described in 3GPP TS 38.331. The UE 110 may derive measurement results by measuring one or multiple cells configured by the network. The cells measured by the UE 100 may include candidate cells in the conditional reconfiguration and the neighbor cells of the UE 100. For example, the UE 110 may perform measurement on reference signals (e.g., Synchronization Signal Block (SSB) or Channel State Information Reference Signal (CSI-RS)) for both candidate cells in conditional reconfirmation and neighboring cells. The network may configure the UE 110 to report the measurement result in accordance with a measurement configuration.

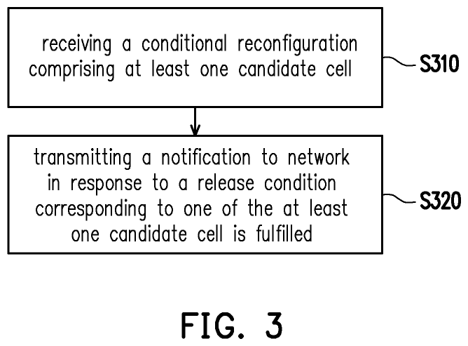

FIG. 3 is a flow chart of a method of conditional reconfiguration according to an embodiment of the disclosure. Referring to FIG. 3, the method of the embodiment is adapted to the UE 110 in FIG. 1 and FIG. 2.

In step S310, the UE 110 may receive a conditional reconfiguration comprising at least one candidate cell. The network may configure the UE 110 with one or more candidate cells in the conditional reconfiguration. In some embodiments, the conditional reconfiguration is configured to include one or multiple candidate cells, an execution condition of each candidate cell, and a release condition of each candidate cell. In some embodiments, the UE 110 may receive the conditional reconfiguration by receiving a RRC reconfiguration message from the network through the transceiver 113. After the UE 110 receives the conditional reconfiguration, the conditional reconfiguration may be stored in the storage medium 112.

In some embodiments, the conditional reconfiguration is configured for CPA, CHO or CPC, and the candidate cells in the conditional reconfiguration may be CPA candidate cells, CPC candidate cells or CHO candidate cells. In some embodiments, the candidate cells in the conditional reconfiguration may also be referred to as candidate target SpCells.

In some embodiments, the UE 110 may evaluate the execution condition of each candidate cell and the release condition of each candidate cell. The UE 110 may perform measurement on the candidate cells in the conditional reconfiguration and determine whether the execution condition of each candidate cell and the release condition of each candidate cell are fulfilled according to measurement result (e.g. reference signal received power (RSRP), reference signal received quality (RSRQ), and the like). The UE 110 may perform the handover, the PSCell change, or the PSCell addition as the corresponding execution condition of one of the candidate cells is fulfilled. It should be noted that, the execution condition of each candidate cell may be the same or different, which is not limited in the disclosure.

In some embodiments, upon determining an execution condition in the conditional reconfiguration is fulfilled, the UE 110 may perform the handover, the PSCell change, or the

PSCell addition to attempt to access a candidate target SpCell that satisfies the execution condition. In some embodiments, the execution condition of each candidate cell may include a threshold parameter, a time to trigger (TTT) parameter or the combination thereof. In one embodiment, the UE 110 may determine whether measurement result of the candidate cell is greater than the threshold parameter of the execution condition. Alternatively, in one embodiment, the UE 110 may determine whether measurement result of the candidate cell is continuously greater than the threshold parameter of the execution condition for a time to trigger parameter.

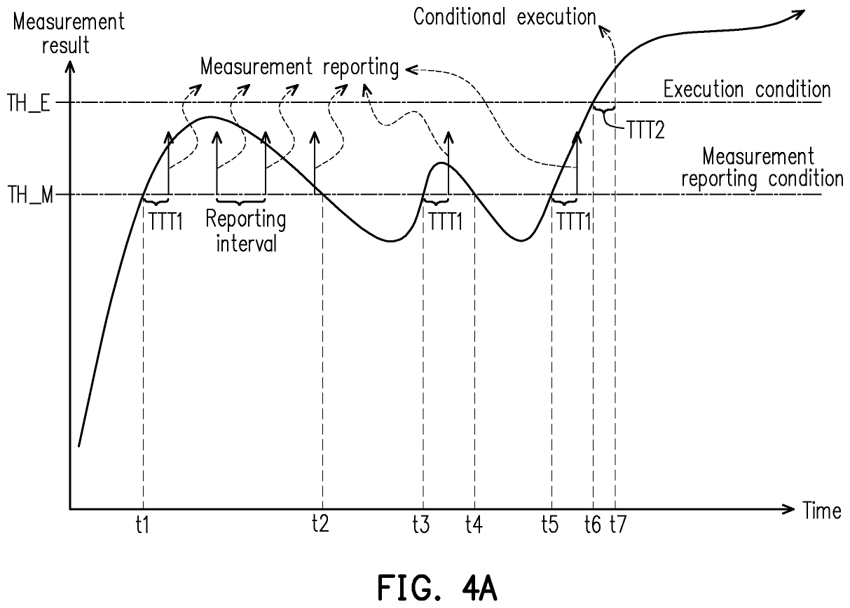

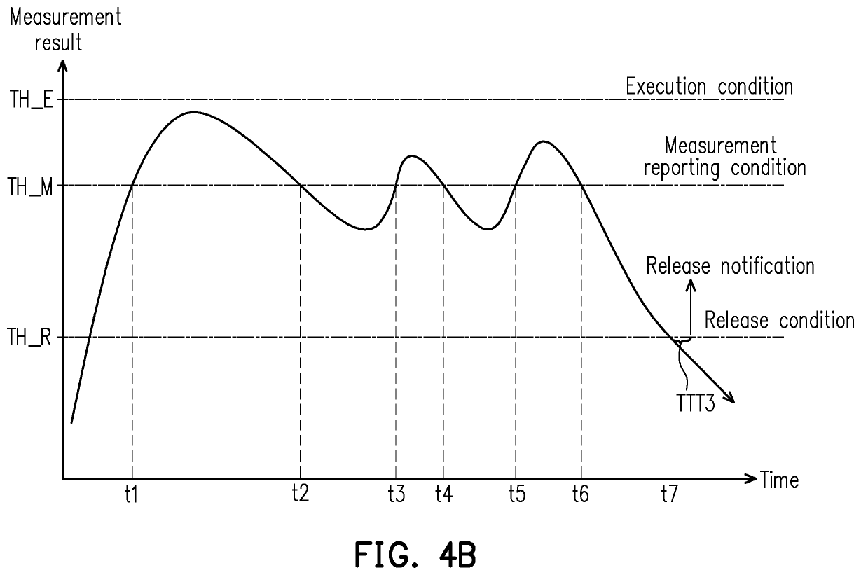

For example, FIG. 4A is a schematic diagram illustrating fulfillment of an execution condition according to an exemplary embodiment of the disclosure. Referring to FIG. 4A, the UE 110 may perform measurement on one of the candidate cells in the conditional reconfiguration to obtain measurement result showing in 4A. The UE 110 may perform measurement reporting if the measurement result of the candidate cell satisfies a measurement reporting condition. The measurement reporting condition may be obtained by the UE 110 through the measurement configuration as specified in 3GPP TS 38.331. At times t1, t3 and t5, the measurement result become greater than a threshold parameter TH_M. Since the measurement result is continuously greater than the threshold parameter TH_M for a period TTT1, the UE 110 may start to report the measurement result periodically. At times t2 and t4, the measurement result become less than the threshold parameter TH_M, the UE 110 may stop reporting the measurement result. It should be noted that, at time t6, the measurement result become greater than a threshold parameter TH_E. Further, the measurement result is continuously greater than the threshold parameter TH_E for a time to trigger parameter TTT2, the UE 110 may determine the execution condition is fulfilled. Therefore, the UE 110 may perform conditional execution for CHO, CPC, or CPA regarding to the candidate cell at time t7.

In step S320, the UE 110 may transmit a notification to the network in response to a release condition corresponding to one of the at least one candidate cell is fulfilled. That is, the

UE 110 may transmit the notification to notify the network of fulfillment of the release condition corresponding to one of the at least one candidate cell. In one embodiment, the UE 110 may transmit the notification via RRC reconfiguration complete message. In one embodiment, the UE 110 may transmit the notification via measurement reporting message. In one embodiment, the UE 110 may transmit the notification via other dedicate message. Correspondingly, one of the at least on candidate cell in the conditional reconfiguration may be released by the UE 110 and the network if the corresponding release condition of the one of the at least on candidate cell is fulfilled. It should be noted that, the release condition of each candidate cell may be the same or different, which is not limited in the disclosure. Therefore, when determining a release condition in the conditional reconfiguration is fulfilled, the UE 110 and the network may release a candidate cell satisfying the release condition, such that the candidate cells in the conditional reconfiguration are able to be modified according to information provided by the UE 110 (e.g. measurement result). Besides, the resource (e.g., dedicated Random Access Channel (RACH) preamble and Cell Radio Network Temporary Identifier (C-RNTI)) reserved by the candidate cell satisfying the release condition may be released as well.

More specifically, in some embodiments, the UE 110 may release one of the at least one candidate cell in the conditional reconfiguration in response to the release condition corresponding to the one of the at least one candidate cell is fulfilled. That is, the UE 110 may release the one of the at least one candidate cell in the conditional reconfiguration by itself without any network command. Alternatively, in some embodiments, after transmitting the notification to the network upon fulfillment of the release condition corresponding to the one of the at least one candidate cell, the UE 110 may receive a release command corresponding to the one of the at least one candidate cell in the conditional reconfiguration from the network. The UE 110 may release the one of the at least one candidate cell in the conditional reconfiguration in response to the release command. That is, the UE 110 may release the one of the at least one candidate cell in the conditional reconfiguration in response to receiving the release command from the network.

In some embodiments, each of the candidate cells is associated with at least one corresponding release condition in the conditional reconfiguration. Further, the release condition in the conditional reconfiguration may include a common release condition for all candidate cells, at least one dedicate release condition for each candidate cell, or the combination thereof. In some embodiments, the release condition of each candidate cell may include a threshold parameter, a time to trigger parameter or the combination thereof. In one embodiment, the UE 110 may evaluate the release condition by determining whether measurement result of the candidate cell is less than the threshold parameter of the release condition. Alternatively, in one embodiment, the UE 110 may evaluate the release condition by determining whether measurement result of the candidate cell is continuously less than the threshold parameter of the release condition for a time to trigger parameter.

For example, FIG. 4B is a schematic diagram illustrating fulfillment of a release condition according to an exemplary embodiment of the disclosure. Referring to FIG. 4B, the UE 110 may perform measurement on one of the candidate cells in the conditional reconfiguration to obtain measurement result showing in 4B. Similar to example of FIG. 4A, the UE 110 may report measurement results periodically during the time period between the time t1 to t2, the time period between the time t3 to t4 and the time period between the time t5 to t6 since the measurement result of the candidate cell satisfies a measurement reporting condition. It should be noted that, at the time t7, the measurement result becomes less than the threshold parameter TH_R. In one embodiment, the threshold parameter TH_R of the release condition may be less than the threshold parameter TH_M of the measurement reporting condition and the threshold parameter TH_E of the execution condition. Afterward, since the measurement result is continuously less than the threshold parameter TH_R for a time to trigger parameter TTT3, the UE 110 may determine the release condition of the candidate cell is fulfilled and transmit the release notification. Therefore, the candidate cell satisfying the release condition may be released by the UE 110 and the network. In one embodiment, upon fulfillment of a release condition, the UE 110 may remove the candidate cell satisfied the release condition from the candidate cell list in the stored conditional reconfiguration. In one embodiment, upon fulfillment of a release condition, the UE 110 may notify the network of the fulfillment of the release condition by transmitting the release notification, and then the network may remove the candidate cell satisfying the release condition from the candidate cell list of the configured conditional reconfiguration. Accordingly, after the candidate cell satisfying the release condition is removed from the conditional reconfiguration, the UE 110 may stop evaluating any execution condition and any release condition for the removed candidate cell.

In one embodiment, in addition to a threshold parameter and a time to trigger parameter, the release condition further comprises a cell number of candidate cell. In one embodiment, the cell number of candidate cell includes a UE capable candidate cell number. In one embodiment, if the measurement result of one of the at least one candidate cell satisfies the release condition and the number of the at least one candidate cell in the conditional reconfiguration is equal to the UE capable candidate cell number, the UE 110 and the network may release the one of the at least one candidate cell satisfying the release condition. Otherwise, if the measurement result of one of the at least one candidate cell satisfies the release condition but the number of the at least one candidate cell in the conditional reconfiguration is less than the UE capable candidate cell number, the UE 110 and the network may not release the one of the at least one candidate cell satisfying the release condition. For example, assuming the UE 110 is able to support 4 candidate cells. If the conditional reconfiguration includes only 3 candidate cells which is less than the UE capable candidate cell number, the candidate cell may not be released even though the measurement result thereof satisfies the release condition.

In one embodiment, one or multiple neighbor cells can either be detected by the UE 110 or configured by the network. Depending on the movement of the UE 110, there may be a neighbor cell becoming competent to be the candidate cells. Therefore, an addition condition of a neighbor cell is configured for determining whether the neighbor cell is qualified to be one candidate cell in the conditional reconfiguration. An addition condition of a neighbor cell may be configured and transmitted to the UE 110. In other words, the network may configure addition condition for each neighbor cell of the UE 110. Upon receiving the addition condition of the neighbor cell, the UE 110 may start to evaluate the addition condition of the neighbor cell. The neighbor cell may be added into the conditional reconfiguration to be one candidate cell as the addition condition of the neighbor cell is fulfilled. That is, a neighbor cell satisfying the addition condition may be referred to as a potential cell that is competent to be one candidate cell for CPA, CHO or CPC.

Different exemplary embodiments of notifying the network of fulfillment of the release condition are described below.

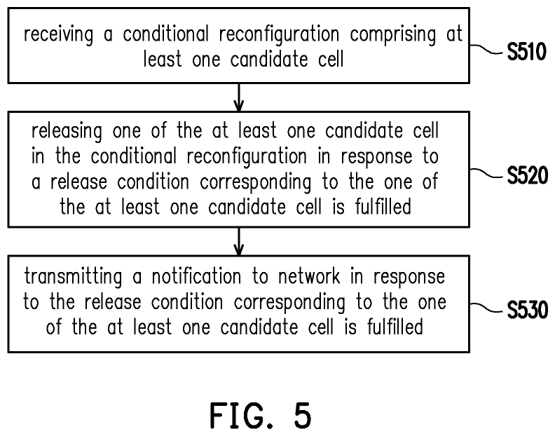

FIG. 5 is a flow chart of a method of conditional reconfiguration according to an embodiment of the disclosure. Referring to FIG. 5, in step S510, the UE 110 may receive a conditional reconfiguration comprising at least one candidate cell. In step S520, the UE 110 may release one of the at least one candidate cell in the conditional reconfiguration in response to a release condition corresponding to the one of the at least one candidate cell is fulfilled. In step S530, the UE 110 may transmit a notification to network in response to the release condition corresponding to the one of the at least one candidate cell is fulfilled.

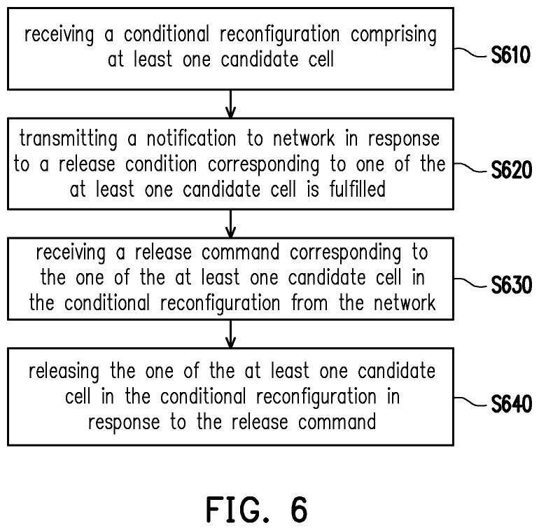

FIG. 6 is a flow chart of a method of conditional reconfiguration according to an embodiment of the disclosure. Referring to FIG. 6, in step S610, the UE 110 may receive a conditional reconfiguration comprising at least one candidate cell. In step S620, the UE 110 may transmit a notification to network in response to a release condition corresponding to one of the at least one candidate cell is fulfilled. In step S630, the UE 110 may receive a release command corresponding to the one of the at least one candidate cell in the conditional reconfiguration from the network. In step S640, the UE 110 may release the one of the at least one candidate cell in the conditional reconfiguration in response to the release command.

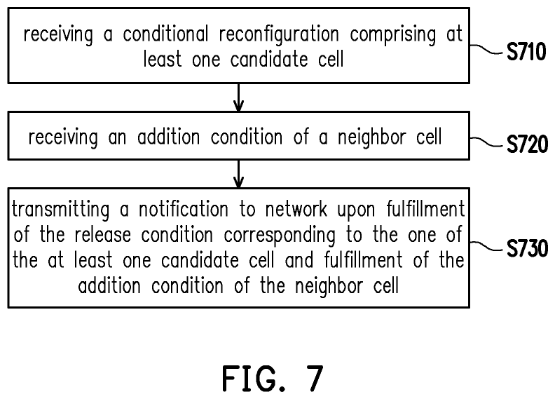

FIG. 7 is a flow chart of a method of conditional reconfiguration according to an embodiment of the disclosure. Referring to FIG. 7, in step S710, the UE 110 may receive a conditional reconfiguration comprising at least one candidate cell. In an embodiment, step S710 is similar to steps 5310 in FIG. 3. In step S720, the UE 110 may receive an addition condition of a neighbor cell. In some embodiments, the UE 110 may receive the addition condition through a RRC reconfiguration message. In some embodiments, the UE 110 may receive the addition condition via the conditional reconfiguration. That is, the addition condition is added into the conditional reconfiguration by the network, and the UE 110 may simultaneously obtain the execution condition of each candidate cell, the release condition of each candidate cell and the addition condition of each neighbor cell from the received conditional reconfiguration. Alternatively, in some embodiments, when the network configures measurement configuration of each neighbor cell, the network may configure the addition condition of each neighbor cell at the same time. It should be noted that, the addition condition of each neighbor cell may be the same or different, which is not limited in the disclosure.

In some embodiments, the UE 110 may evaluate the execution condition of each candidate cell and the release condition of each candidate cell. Besides, the UE 110 may evaluate the addition condition of the neighbor cell. The number of the neighbor cells configured with the addition conditions is not limited in the disclosure. In some embodiments, the UE 110 may perform measurement on one or multiple neighbor cells of the UE 110 and determine whether the addition condition of each neighbor cell is fulfilled according to measurement result (e.g. reference signal received power (RSRP), reference signal received quality (RSRQ), and the like). In some embodiments, the addition condition comprises a threshold parameter, a time to trigger parameter or a combination thereof. In one embodiment, the UE 110 may determine whether measurement result of the neighbor cell is greater than the threshold parameter of the addition condition. Alternatively, in one embodiment, the UE 110 may determine whether measurement result of the neighbor cell is continuously greater than the threshold parameter of the addition condition for a time to trigger parameter.

In some embodiments, in addition to a threshold parameter and a time to trigger parameter, the addition condition further comprises a cell number of candidate cell. In one embodiment, the cell number of candidate cell includes a UE capable candidate cell number. In one embodiment, if the measurement result of the neighbor cell satisfies the addition condition and the number of the at least one candidate cell in the conditional reconfiguration is less than the UE capable candidate cell number, the UE 110 may add the neighbor cell into the conditional reconfiguration to be a new candidate cell. Otherwise, if the measurement result of the neighbor cell satisfies the addition condition but the number of the at least one candidate cell in the conditional reconfiguration is equal to the UE capable candidate cell number, the UE 110 may not add the neighbor cell into the conditional reconfiguration to be a new candidate cell.

For example, assuming the UE 110 is able to support 4 candidate cells. If the conditional reconfiguration includes 4 candidate cells which is equal to the UE capable candidate cell number, the neighbor cell may not be added in to the conditional reconfiguration even though the measurement result thereof satisfies the addition condition.

In step S730, the UE 110 may transmit a notification to network upon fulfillment of the release condition corresponding to the one of the at least one candidate cell and fulfillment of the addition condition of the neighbor cell. Specifically, the UE 110 and the network may release an incompetent candidate cell satisfying the release condition in response to the fulfillment of its release condition. Further, the UE 110 and the network may add the neighbor cell into the conditional reconfiguration to be a new candidate cell in response to the fulfillment of its addition condition. In the embodiment of FIG. 7, the notification may be transmitted by the UE 110 when both of a release condition of one candidate cell and an addition condition of a neighbor cell are fulfilled, and the UE 110 may provide the notification including the incompetent candidate cell that should be released and the neighbor cell that should be added into the conditional reconfiguration. In one embodiment, the notification may include cell information (e.g., cell ID) of the incompetent candidate cell satisfying the release condition and cell information (e.g., cell ID) of the neighbor cell satisfying the addition condition. Therefore, upon receiving the notification from the UE 110, the network may perform candidate cell release and candidate cell addition based on the notification.

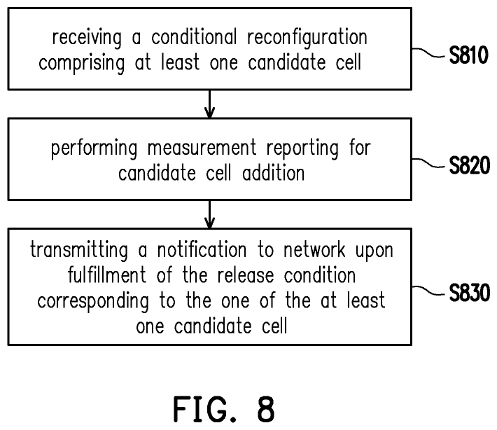

FIG. 8 is a flow chart of a method of conditional reconfiguration according to an embodiment of the disclosure. Referring to FIG. 8, in step S810, the UE 110 may receive a conditional reconfiguration comprising at least one candidate cell. The UE 110 may evaluate the execution condition of each candidate cell and the release condition of each candidate cell.

In step S820, the UE 110 may perform measurement reporting for candidate cell addition. That is, the measurement reporting scheme is leveraged for candidate cell addition. The network may add new candidate cell(s) based on measurements if the incompetent candidate cell has been released so that the number of the candidate cells is less than the UE capable candidate cell number. The UE capable candidate cell number may be a maximum number of candidate cell that the UE 110 is capable to support. For example, the UE capable candidate cell number may be 4. In the measurement reporting scheme, the UE 110 may derive measurement results by measuring one or multiple cells configured by the network. The network may configure the UE 110 to report the measurement result in accordance with a measurement configuration. The network may determine whether the measured cell is suitable to be a new candidate cell based on the measurement result. In one embodiment, the network may configure to add the new candidate cell in the conditional reconfiguration to the UE 110 if the network determines that it is suitable to be a new candidate cell and the number of the candidate cells in the conditional reconfiguration prior to the addition is less than the UE capable candidate cell number. Alternatively, in one embodiment, the network may configure to add the new candidate cell in the conditional reconfiguration to the UE 110 if the network determines that it is suitable to be a new candidate cell, and the UE 110 may determine whether to apply the addition configuration according to whether the number of the candidate cells in the conditional reconfiguration prior to the addition is less than the UE capable candidate cell number. If the UE 110 determines that the number of the candidate cells in the conditional reconfiguration prior to the addition is less than the UE capable candidate cell number, the UE 110 may apply the addition configuration. If the UE 110 determines that the number of the candidate cells in the conditional reconfiguration prior to the addition is not less than the UE capable candidate cell number, the UE 110 may not apply the addition configuration.

In step S830, the UE 110 may transmit a notification to network upon fulfillment of the release condition corresponding to the one of the at least one candidate cell. In the embodiment of FIG. 8, the notification may be transmitted by the UE 110 when a release condition of one candidate cell is fulfilled, and the UE 110 may provide the notification including which incompetent candidate cell should be released but not including which cell should be added to be a new candidate cell.

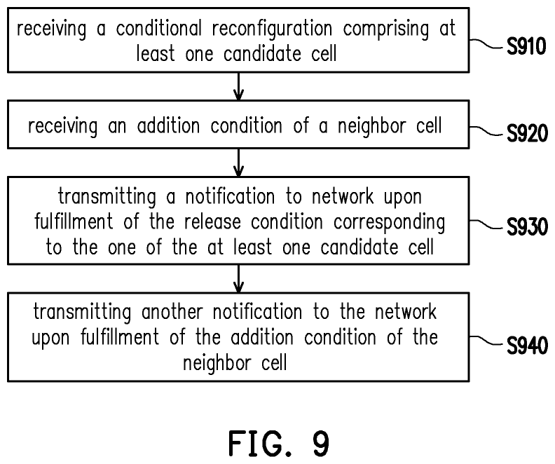

FIG. 9 is a flow chart of a method of conditional reconfiguration according to an embodiment of the disclosure. Referring to FIG. 9, in step S910, the UE 110 may receive a conditional reconfiguration comprising at least one candidate cell. In an embodiment, step S910 is similar to steps S310 in FIG. 3. In step S920, the UE 110 may receive an addition condition of a neighbor cell. In some embodiments, the UE 110 may receive the addition condition through a RRC reconfiguration message. In some embodiments, the UE 110 may receive the addition condition via the conditional reconfiguration. That is, the addition condition is added into the conditional reconfiguration by the network, and the UE 110 may simultaneously obtain the execution condition of each candidate cell, the release condition of each candidate cell and the addition condition of each neighbor cell from the received conditional reconfiguration. Alternatively, in some embodiments, when the network configures measurement configuration of each neighbor cell, the network may configure the addition condition of each neighbor cell at the same time. It should be noted that, the addition condition of each neighbor cell may be the same or different, which is not limited in the disclosure.

It should be noted that, in step S930, the UE 110 may transmit a notification to network upon fulfillment of the release condition corresponding to the one of the at least one candidate cell. In step S940, the UE 110 may transmit another notification to the network upon fulfillment of the addition condition of the neighbor cell. Note that the execution order of the steps S930 and S940 is not limited in the disclosure. That is, no matter the addition condition is fulfilled or not, once the release condition of the one of the candidate cells is fulfilled, transmission of the notification for release may be performed. Similarly, no matter the release condition is fulfilled or not, once the addition condition of the neighbor cell is fulfilled, transmission of the notification for addition may be performed. In one embodiment, the notification for release may include cell information (e.g., cell ID) of the incompetent candidate cell satisfying the release condition, and the another notification for addition may include cell information (e.g., cell ID) of the neighbor cell satisfying the addition condition. Accordingly, the network may perform candidate cell release upon receiving the notification, and the network may perform candidate cell addition upon receiving the another notification.

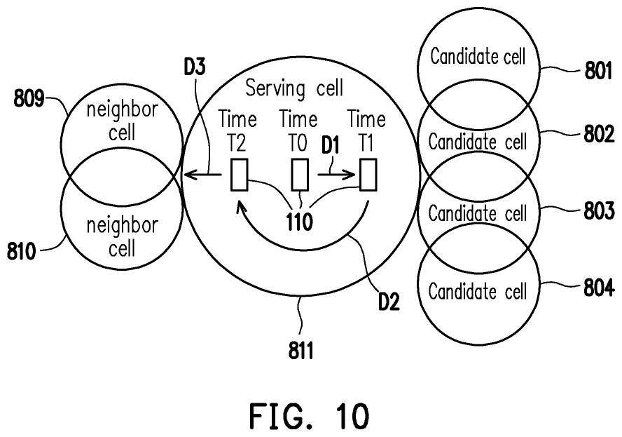

FIG. 10 is a schematic diagram illustrating releasing the candidate cells and adding new candidate cells according to an embodiment of the disclosure. Referring to FIG. 10, at time T0, the UE 110 is at a cell center of the serving cell 811. During the period between time T0 and time T1, the UE 110 moves along a first direction D1 to a right position within the serving cell 811. At this moment, the network may configure a conditional reconfiguration including 4 candidate cells 801, 802, 803 and 804 for the UE 110 to handle the various possibilities of the UE 110 leaving the serving cell 811 from the upper right direction, the horizontal direction or the lower left direction. The UE 110 may receive the conditional reconfiguration including 4 candidate cells set above. Assume that the UE capable candidate cell number that the UE 110 is capable to support is 4. During the period between time T1 and time T2, the UE 110 moves along a second direction D2 to a left position within the serving cell 811. At time T2, the UE 110 starts to move along a third direction D3 away from the serving cell 811. In the case, the UE 110 may find that the candidate cells 801 and 804 become incompetent based on the fulfillment of their corresponding release conditions. Since the release conditions of the candidate cells 801 and 804 are fulfilled, the UE 110 may release the candidate cells 801 and 804. On the other hand, after time T2, the UE 110 may find that the neighbor cells 809 and 810 become competent to be candidate cells based on the fulfillment of their corresponding addition conditions. Since the candidate cells 801 and 804 are released so that the number of the candidate cells for the UE 110 is less than the UE capable candidate cell number and the addition conditions of the neighbor cells 809 and 810 are fulfilled after time T2, the neighbor cells 809 and 810 may be added into the conditional reconfiguration to be new candidate cells for the UE 110. In this way, the candidate cells in the conditional reconfiguration may be modified.

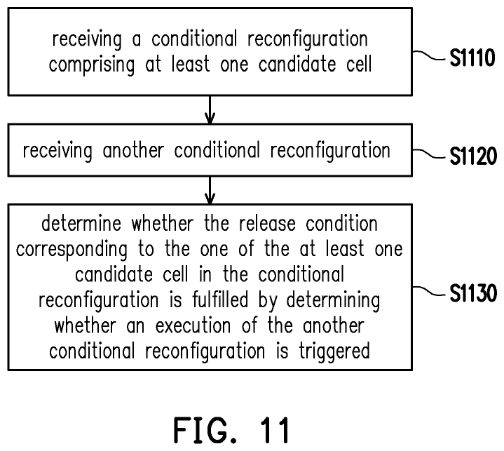

FIG. 11 is a flow chart of a method of conditional reconfiguration according to an embodiment of the disclosure. Referring to FIG. 11, in step S1110, the UE 110 may receive a conditional reconfiguration comprising at least one candidate cell. In step S1120, the UE 110 may receive another conditional reconfiguration. The another conditional reconfiguration may also comprise at least one candidate cell and execution condition of each candidate cell. For example, the conditional reconfiguration may be configured for intra-SN CPC without MN involvement, and the another conditional reconfiguration may be configured for inter-SN CPC with MN involvement. Note that the order of receiving the conditional reconfiguration and receiving the another conditional reconfiguration is not limited in the disclosure. In the embodiment of FIG. 11, the release condition corresponding to the one of the at least one candidate cell in the conditional reconfiguration comprises an execution of the another conditional reconfiguration, and such release condition may be common for all candidate cells in the conditional reconfiguration. Accordingly, in step S1130, the UE 110 may determine whether the release condition corresponding to the one of the at least one candidate cell in the conditional reconfiguration is fulfilled by determining whether an execution of the another conditional reconfiguration is triggered. In detail, the UE 110 may receive the conditional reconfiguration which may include a common release condition and the another conditional reconfiguration which may include one or more execution conditions, wherein each execution condition corresponds to a candidate cell in the another conditional reconfiguration, and the common release condition in the conditional reconfiguration is whether an execution condition in the another conditional reconfiguration is fulfilled. Once the execution condition of one candidate cell in the another conditional reconfiguration is fulfilled, the UE 110 may determine that the common release condition of the conditional reconfiguration is fulfilled.

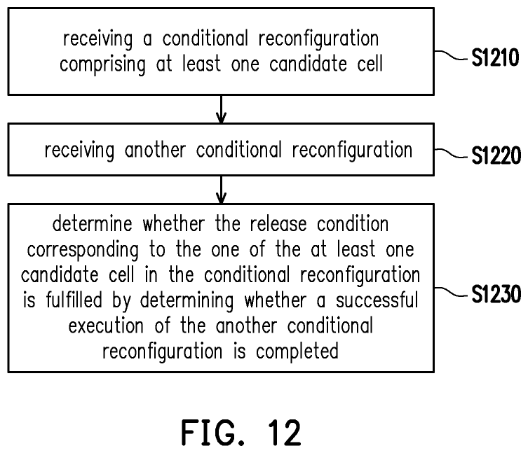

FIG. 12 is a flow chart of a method of conditional reconfiguration according to an embodiment of the disclosure. Referring to FIG. 12, in step S1210, the UE 110 may receive a conditional reconfiguration comprising at least one candidate cell. In step S1220, the UE 110 may receive another conditional reconfiguration. The another conditional reconfiguration may also comprise at least one candidate cell and execution condition of each candidate cell. For example, the conditional reconfiguration may be configured for intra-SN CPC without MN involvement, and the another conditional reconfiguration may be configured for inter-SN CPC with MN involvement. Note that the order of receiving the conditional reconfiguration and receiving the another conditional reconfiguration is not limited in the disclosure. In the embodiment of FIG. 12, the release condition corresponding to the one of the at least one candidate cell in the conditional reconfiguration comprises a successful execution of the another conditional reconfiguration, and such release condition may be common for all candidate cells in the conditional reconfiguration. Accordingly, in step S1230, the UE 110 may determine whether the release condition corresponding to the one of the at least one candidate cell in the conditional reconfiguration is fulfilled by determining whether a successful execution of the another conditional reconfiguration is completed. In detail, the UE 110 may receive the conditional reconfiguration which may include a common release condition and the another conditional reconfiguration which may include one or more execution conditions, wherein each execution condition corresponds to a candidate cell in the another conditional reconfiguration, and the common release condition in the conditional reconfiguration is whether an execution condition in the another conditional reconfiguration is fulfilled and whether the execution of the another conditional reconfiguration is successfully completed. Upon the successful execution of the another conditional reconfiguration, the UE 110 may determine that the common release condition of the conditional reconfiguration is fulfilled. Namely, once the execution condition of one candidate cell in the another conditional reconfiguration which may be for CHO, CPC, or CPA is fulfilled and the associated execution of CHO, CPC, or CPA is completed, the UE 110 may determine that the common release condition of the conditional reconfiguration is fulfilled.

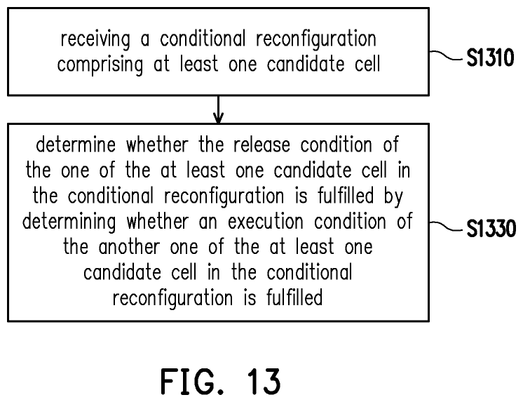

FIG. 13 is a flow chart of a method of conditional reconfiguration according to an embodiment of the disclosure. Referring to FIG. 13, in step S1310, the UE 110 may receive a conditional reconfiguration comprising at least one candidate cell. In the embodiment of FIG. 13, the release condition of one of the at least one candidate cell in the conditional reconfiguration comprises an execution condition of another one of the at least one candidate cell in the conditional reconfiguration. Accordingly, in step S1330, the UE 110 may determine whether the release condition of the one of the at least one candidate cell in the conditional reconfiguration is fulfilled by determining whether an execution condition of the another one of the at least one candidate cell in the conditional reconfiguration is fulfilled. That is, the release condition of the candidate cell is fulfilled if the execution condition of the another candidate cell is fulfilled. The candidate cell may be released if the execution condition of the another candidate cell in the same conditional reconfiguration is fulfilled. For example, assuming there are 4 candidate cells, each denoted by #1, #2, #3 and #4, in one conditional reconfiguration. The release condition of the candidate cell #2 is the execution condition of the candidate cell #1 in the same conditional reconfiguration. Once the execution condition of the candidate cell #1 is fulfilled, the candidate cell #2 may be released from the conditional reconfiguration.

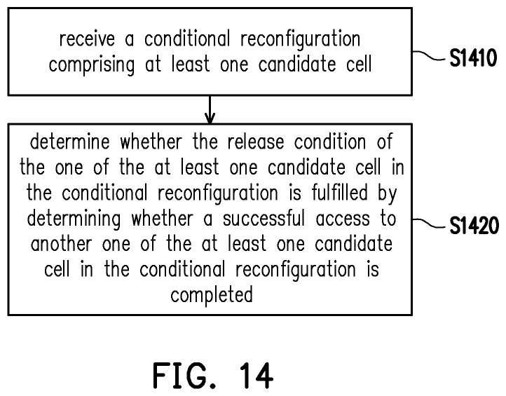

FIG. 14 is a flow chart of a method of conditional reconfiguration according to an embodiment of the disclosure. Referring to FIG. 14, in step S1410, the UE 110 may receive a conditional reconfiguration comprising at least one candidate cell. In the embodiment of FIG. 14, the release condition of one of the at least one candidate cell in the conditional reconfiguration comprises a successful access to another one of the at least one candidate cell in the conditional reconfiguration. Accordingly, in step S1420, the UE 110 may determine whether the release condition of the one of the at least one candidate cell in the conditional reconfiguration is fulfilled by determining whether a successful access to the another one of the at least one candidate cell in the conditional reconfiguration is completed. The candidate cell may be released if the UE 110 has successfully accessed to the another candidate cell in the same conditional reconfiguration.

The procedure of the method of conditional reconfiguration executed by a UE is not limited to the examples in the above embodiment. For example, some of the above-described steps may be omitted, or the steps may be executed in a different order. Further, other steps may be executed in addition to the above steps.

In summary of the above, in the embodiments of the disclosure, the network configures conditional reconfiguration to UE with not only execution condition but also release condition of each candidate cell, and the UE measures each candidate cell to evaluate both of the execution condition and the release condition of each candidate cell. One of the candidate cells in the conditional reconfiguration may be released as the corresponding release condition of the one of the candidate cells is fulfilled. Therefore, the candidate cells for CHO, CPC or CPA in the conditional reconfiguration may be modified dynamically based on the information provided by the UE (e.g. measurement result). Such that, the incompetent candidate cell may be released from the conditional reconfiguration, and the resource reserved by the incompetent candidate cell would not be wasted. In the embodiments of the disclosure, since the conditional reconfiguration may be dynamically modified to include the candidate cells that are more suitable for UE, probability of handover failure or RLF may be reduced.

Although the invention has been described in terms of embodiments as above, the embodiments are not intended to limit the invention. It will be apparent to those of ordinary skill in the art that some changes and modifications may be made without departing from the spirit and scope of the invention. Therefore, the scope of the invention shall be defined by the appended claims.

What is claimed is:

1. A method of conditional reconfiguration, adapted to a user equipment (UE), the method comprising:
receiving a conditional reconfiguration comprising at least one candidate cell; and
transmitting a notification to network in response to a release condition corresponding to one of the at least one candidate cell is fulfilled.

2. The method of conditional reconfiguration according to claim 1, wherein the method further comprises:
releasing the one of the at least one candidate cell in the conditional reconfiguration in response to the release condition corresponding to the one of the at least one candidate cell is fulfilled.

3. The method of conditional reconfiguration according to claim 1, wherein the method further comprises:
receiving a release command corresponding to the one of the at least one candidate cell in the conditional reconfiguration from the network; and
releasing the one of the at least one candidate cell in the conditional reconfiguration in response to the release command.

4. The method of conditional reconfiguration according to claim 1, wherein the conditional reconfiguration is configured for Conditional PSCell Addition (CPA), Conditional Handover (CHO) or Conditional PSCell Change (CPC).

5. The method of conditional reconfiguration according to claim 1, wherein the release condition comprises a cell number of candidate cell.

6. The method of conditional reconfiguration according to claim 1, wherein the method further comprises:
receiving an addition condition of a neighbor cell,
wherein the neighbor cell is added into the conditional reconfiguration to be one candidate cell in response to the addition condition of the neighbor cell is fulfilled.

7. The method of conditional reconfiguration according to claim 6, wherein the addition condition comprises a cell number of candidate cell.

8. The method of conditional reconfiguration according to claim 6, wherein the notification is transmitted to the network upon fulfillment of the release condition of the one of the at least one candidate cell and fulfillment of the addition condition of the neighbor cell.

9. The method of conditional reconfiguration according to claim 6, wherein the method further comprises:
transmitting another notification to the network in response to the addition condition of the neighbor cell is fulfilled.

10. The method of conditional reconfiguration according to claim 1, wherein the method further comprises:
receiving another conditional reconfiguration,
wherein the release condition corresponding to the one of the at least one candidate cell comprises an execution of the another conditional reconfiguration.

11. The method of conditional reconfiguration according to claim 1, wherein the method further comprises:
receiving another conditional reconfiguration,
wherein the release condition corresponding to the one of the at least one candidate cell comprises a successful execution of the another conditional reconfiguration.

12. The method of conditional reconfiguration according to claim 1, wherein the release condition corresponding to the one of the at least one candidate cell comprises an execution condition of another one of the at least one candidate cell in the conditional reconfiguration.

13. The method of conditional reconfiguration according to claim 1, wherein the release condition corresponding to the one of the at least one candidate cell comprises a successful access to another one of the at least one candidate cell in the conditional reconfiguration.

14. A user equipment, comprising:
a transceiver configured to receive and transmit a signal; and
a processor coupled to the transceiver and configured to:
receive a conditional reconfiguration comprising at least one candidate cell; and
transmit a notification to network in response to a release condition corresponding to one of the at least one candidate cell is fulfilled.

15. The user equipment according to claim 14, wherein the processor is configured to:
release the one of the at least one candidate cell in the conditional reconfiguration in response to the release condition corresponding to the one of the at least one candidate cell is fulfilled.

16. The user equipment according to claim 14, wherein the processor is configured to:
receive a release command corresponding to the one of the at least one candidate cell in the conditional reconfiguration from the network; and
release the one of the at least one candidate cell in the conditional reconfiguration in response to the release command.

17. The user equipment according to claim 14, wherein the conditional reconfiguration is configured for Conditional PSCell Addition (CPA), Conditional Handover (CHO) or Conditional PSCell Change (CPC).

18. The user equipment according to claim 14, wherein the release condition comprises a cell number of candidate cell.

19. The user equipment according to claim 14, wherein the processor is configured to:
receive an addition condition of a neighbor cell,
wherein the neighbor cell is added into the conditional reconfiguration to be one candidate cell in response to the addition condition of the neighbor cell is fulfilled.

20. The user equipment according to claim 19, wherein the addition condition comprises a cell number of candidate cell.

21. The user equipment according to claim 19, wherein the notification is transmitted to the network upon fulfillment of the release condition of the one of the at least one candidate cell and fulfillment of the addition condition of the neighbor cell.

22. The user equipment according to claim 19, wherein the processor is configured to:
transmit another notification to the network in response to the addition condition of the neighbor cell is fulfilled.

23. The user equipment according to claim 14, wherein the processor is configured to:
receive another conditional reconfiguration,
wherein the release condition corresponding to the one of the at least one candidate cell comprises an execution of the another conditional reconfiguration.

24. The user equipment according to claim 14, wherein the processor is configured to:
receive another conditional reconfiguration,
wherein the release condition corresponding to the one of the at least one candidate cell comprises a successful execution of the another conditional reconfiguration.

25. The user equipment according to claim 14, wherein the release condition corresponding to the one of the at least one candidate cell comprises an execution condition of another one of the at least one candidate cell in the conditional reconfiguration.

26. The user equipment according to according to claim 14, wherein the release condition corresponding to the one of the at least one candidate cell comprises a successful access to another one of the at least one candidate cell in the conditional reconfiguration.
